(19) United States
(12) Patent Application Publication
(10) Pub. No.: US 2015/0188636 A1
(43) Pub. Date: Jul. 2, 2015

(54) OPTICAL TRANSCEIVER

(71) Applicant: DELTA ELECTRONICS, INC., Taoyuan Hsien (TW)

(72) Inventors: Li-Hua SU, Taoyuan County (TW); Chun-Ching HO, Taoyuan County (TW)

(21) Appl. No.: 14/498,570

(22) Filed: Sep. 26, 2014

(30) Foreign Application Priority Data
Dec. 31, 2013 (CN) 201310752936.5

(51) Int. Cl. H04B 10/40; H04B 10/00

(52) U.S. Cl. CPC H04B 10/40; H04B 10/12

(57) ABSTRACT

An optical transceiver is provided and connected to a display surface, including a main body, a slider, an elastic element, a movable element, and a circuit board. The main body comprises a base and a cover. A protrusion and a groove are formed on a side of the main body, and the groove extends along a direction toward the protrusion. The circuit board is clamped between the base and the cover and not parallel to the protruding direction of the protrusion. The slider is movably connected to the groove. The elastic element is connected between the slider and the main body. The movable element is connected to the main body and the slider.

### CROSS REFERENCE TO RELATED APPLICATIONS

The present application is based on, and claims priority from, China Patent Application No. 201310752936.5, filed on Dec. 31, 2013, the disclosure of which is hereby incorporated by reference herein in its entirety.

### BACKGROUND OF THE INVENTION

1. Field of the Invention

The application relates in general to an optical transceiver, and in particular, to an optical transceiver which can be easily assembled and disassembled.

2. Description of the Related Art

With rapid progresses in computer and communication technologies, people can easily access information or provide service through the Internet. Due to the enormous data transmission capacity of optoelectronic communication devices, the optoelectronic industry and its products are highly valued by consumers. Currently, the optoelectronic industry, which combines the electronics industry and the optical industry, has seen a great progress in the development of optical transceiver modules, which may include at least an optical transmitter and an optical receiver, or include an integrated optical transceiver that performs both functions.

The transmitter can transform electronic signals into optical signals and transmit the optical signals to an optical fiber. Generally, the transmitters can be classified by the light source, such as a light emitting diode (LED) or a laser diode. Since the laser diodes have the advantages of high output power, fast transmission speeds, small emission angles (i.e. a high efficiency for coupling light source into an optical fiber), and narrow frequency spectrums (small dispersion), they are suitable for mid- or long-range transmission. While the LEDs have the advantages of low cost and simple configuration (simple driving and compensation circuits), they are suitable for short-range transmission. In particular, as the laser diodes (or semiconductor laser diodes) have the advantages of small sizes, low power consumption, quick response, good collision resistance, long lifespans, and high efficiency, they have been widely used in the application of optoelectronic products.

The main function of the optical receiver is to convert an optical signal into an electronic signal, and the most critical component therein is the detector. The detector can generate an electrical current signal by receiving light through a photodiode to excite pairs of electrons and holes therein.

In recent years, the optical transceiver module has been capable of being hot-plugged into the communication set for the purpose of easy inspection. However, detachment of the conventional optical transceiver module is difficult, such that the transmitter and receiver can be easily broken. Furthermore, along with the trend wherein the optical transceiver module gradually becomes smaller, the transmitter and receiver are hard to dispose inside the optical transceiver module. Therefore, how to provide an optical transceiver module within a large receiving space has become an important issue.

### BRIEF SUMMARY OF INVENTION

To address the deficiencies of the conventional optical transceiver module, an embodiment of the invention provides an optical transceiver, comprising a main body, a slider, an elastic element, a movable element, and a circuit board. The main body comprises a base and a cover. A protrusion and a groove are formed on a side of the main body, and the groove extends along a direction toward the protrusion. The circuit board is clamped between the base and the cover and not parallel to the protruding direction of the protrusion. The slider is movably connected to the groove. When an external force is exerted on the slider, the slider is moved from a first position to a second position. The elastic element is connected between the slider and the main body. When the external force is released, the slider is moved from the second position to the first position by the elastic element. The movable element is connected to the main body and the slider and rotates to push the slider along the groove.

In some embodiments, the cover and the base are assembled to each other along a first direction with the circuit board clamped therebetween.

In some embodiments, the optical transceiver further comprises a protecting structure. The protecting structure comprises a plurality of extending portions disposed outside the main body and press-fitted to a housing.

In some embodiments, the circuit board has at least one terminal, connecting with a fiber.

In some embodiments, the cover and the base are assembled to each other by fastening, riveting, or locking.

In some embodiments, the cover and the base have a U-shaped structure.

Another embodiment of the invention provides an optical transceiver, comprising a main body, a slider, an elastic element, a movable element, and a circuit board disposed in the main body. A protrusion and a groove are formed on a side of the main body, and the groove extends along a direction toward the protrusion. The circuit board is not parallel to the protruding direction of the protrusion. The slider is movably connected to the groove. When an external force is exerted on the slider, the slider is moved from a first position to a second position. The elastic element is connected between the slider and the main body. When the external force is released, the slider is moved from the second position to the first position by the elastic element. The movable element is connected to the main body and the slider and rotates to push the slider along the groove.

In some embodiments, the optical transceiver further comprises a protecting structure. The protecting structure comprises a plurality of extending portions disposed outside the main body and press-fitted to a housing.

In some embodiments, the circuit board connects with at least one terminal, connecting with a fiber.

Another embodiment of the invention provides an optical transceiver, comprising a main body, a slider, a protecting structure, a movable element, and a circuit board disposed in the main body. A protrusion and a groove are formed on a side of the main body, and the groove extends along a direction toward the protrusion. The circuit board is not parallel to the protruding direction of the protrusion. The slider is movably connected to the groove. When an external force is exerted on the slider, the slider is moved from a first position to a second position. The protecting structure comprises a plurality of rows of extending portions, disposed outside the main body and press-fitted to a housing. The movable element is connected to the main body and the slider and rotates to push the slider along the groove.

### BRIEF DESCRIPTION OF DRAWINGS

The invention can be more fully understood by reading the subsequent detailed description and examples with references made to the accompanying drawings, wherein:

FIG. 1 is an exploded diagram of an optical transceiver according to an embodiment of the invention;

FIG. 2 is a schematic diagram of the optical transceiver in FIG. 1 according to an embodiment of the invention;

FIGS. 3A and 3B are schematic diagrams of an optical transceiver and a housing according to an embodiment of the invention;

FIG. 4A is a cross-sectional view taken along the line x-x in FIG. 3B; and

FIG. 4B is a schematic diagram representing a movable element rotating relative to a base and a slider sliding along a groove according to an embodiment of the invention.

### DETAILED DESCRIPTION OF INVENTION

The making and using of the embodiments of the optical transceiver are discussed in detail below. It should be appreciated, however, that the embodiments provide many applicable inventive concepts that can be embodied in a wide variety of specific contexts. The specific embodiments discussed are merely illustrative of specific ways to make and use the embodiments, and do not limit the scope of the disclosure.

Unless defined otherwise, all technical and scientific terms used herein have the same meaning as commonly understood to one of ordinary skill in the art to which this invention belongs. It should be appreciated that each term, which is defined in a commonly used dictionary, should be interpreted as having a meaning conforming to the relative skills and the background or the context of the present disclosure, and should not be interpreted by an idealized or overly formal manner unless defined otherwise.

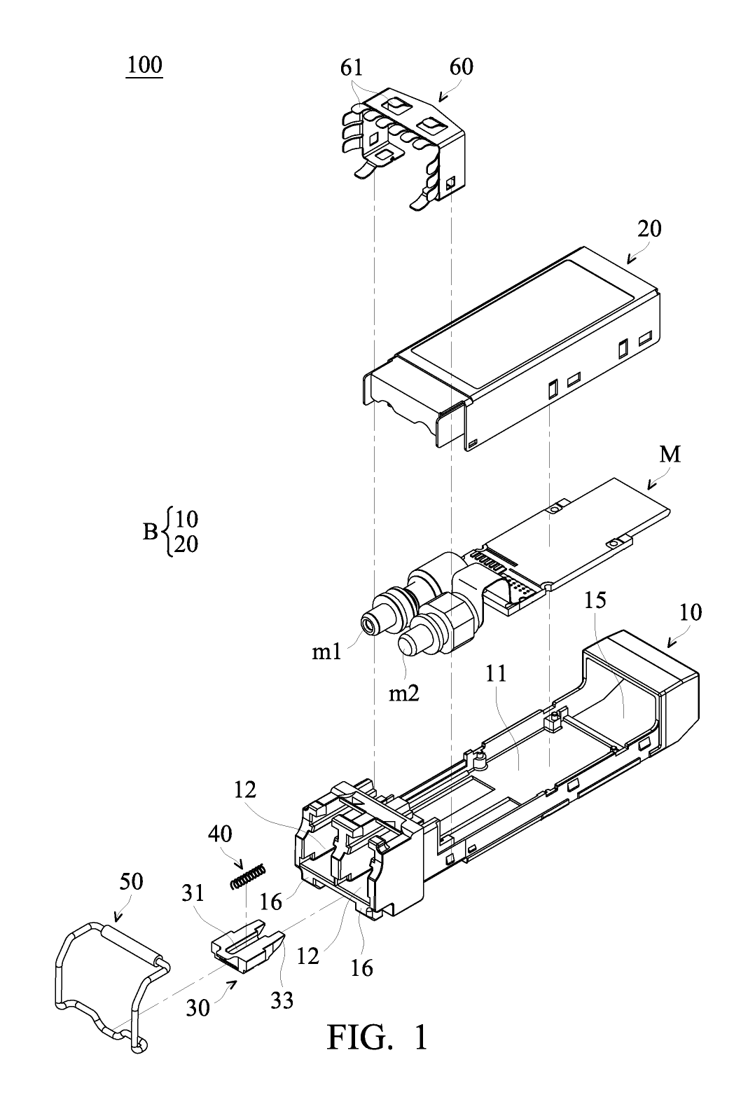

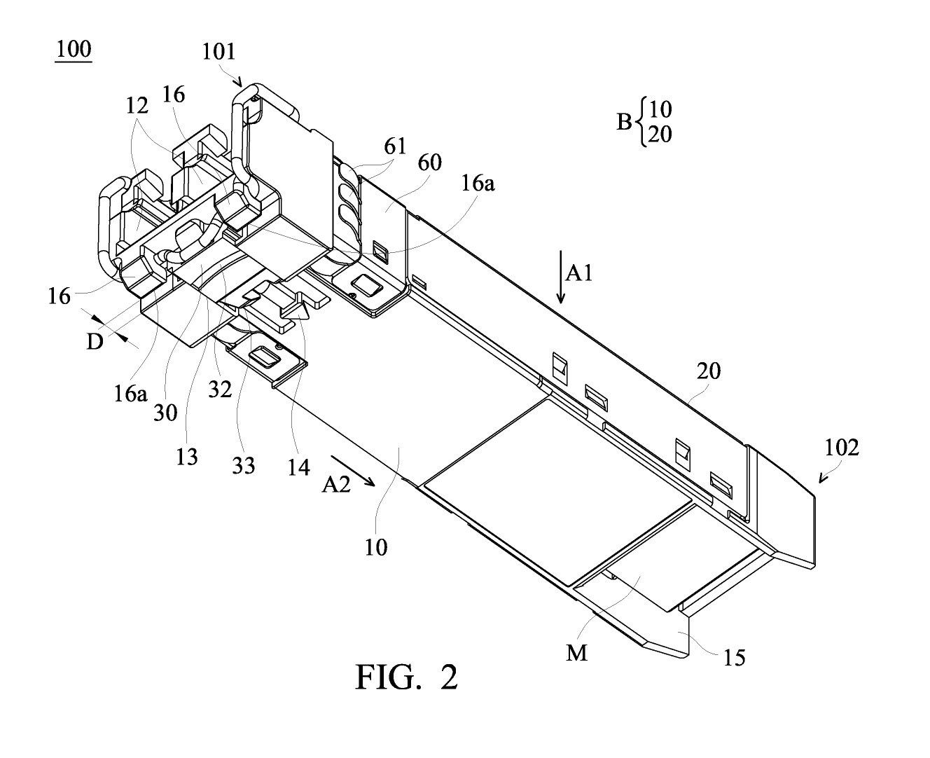

FIG. 1 is an exploded diagram of an optical transceiver 100 according to an embodiment of the invention. Referring to FIGS. 1 and 2, the optical transceiver 100 is an optical transceiver module, including a first end 101 and a second end 102 opposite to the first end 101 (as shown in FIG. 2). The optical transceiver 100 comprises a main body B, a slider 30, an elastic element 40, a movable element 50, a protecting structure 60, and at least one circuit board M. The main body B comprises a base 10 and a cover 20, wherein both the base 10 and the cover 20 may have a U-shaped structure or an I-shaped structure. In this embodiment, a recess 11 and two first holes 12 are formed on the base 10, wherein the first holes 12 are formed at the first end 101, and the recess 11 communicates with the first holes 12.

The cover 20 can be joined to the base 10 along a first direction A1 (FIG. 2) by fastening, riveting, or locking. The circuit board M can be clamped between the base 10 and the cover 20 and accommodated in the recess 11. Therefore, the circuit board M can be stably fixed in the recess 11 without any additional fixing member, and the available space and circuit area with the main body B are enlarged. As shown in FIGS. 1 and 2, the circuit board M is connected with terminals ml, m2. The terminals m1, m2 are exposed to the first holes 12, and a fiber can connect to the terminals ml, m2 through the first holes 12.

Referring to FIG. 2, in this embodiment, a groove 13, a protrusion 14, and a second hole 15 are formed on a side of the main body B. The protruding direction of the protrusion 14 is not parallel to the circuit board M. The groove 13 is formed at the first end 101 and extended toward the protrusion 14 along a second direction A2. The second hole 15 is formed at the second end 102 of the optical transceiver 100 and communicated with the recess 11. The slider 30 is movably accommodated in the recess 13. As shown in FIG. 1, the slider 30 comprises a receiving portion 31, the elastic element 40 is accommodated in the receiving portion 31, wherein the opposite ends of the elastic element 40 respectively connect to the main body B and the slider 30. In this embodiment, the elastic element 40 is a compression spring.

As shown in FIGS. 1 and 2, two L-shaped restricting portions 16 are formed on the base 10 and at the first end 101 of the optical transceiver 100. The groove 13 is disposed between the restricting portions 16. A gap D is formed between an end portion 16a of the constraining portion 16 and the base 10. The movable element 50 comprises an annular structure, wherein a side of the annular structure is restricted between the slider 30 and two restricting portions 16, such that the movable element 50 is fixed to the main body B. The protecting structure 60 is disposed outside the main body B and comprises a plurality of extending portions 61.

It should be noted that a notch 32 is formed on the slider 30 in this embodiment, wherein the notch 32 is extended along a direction perpendicular to the first direction A1 and the second direction A2, such that the slider 30 can be easily pushed for assembly. In some embodiments, the protecting structure 60 and the base 10 may be integrally formed in one piece, wherein the extending portion 61 can be formed on the base 10 directly.

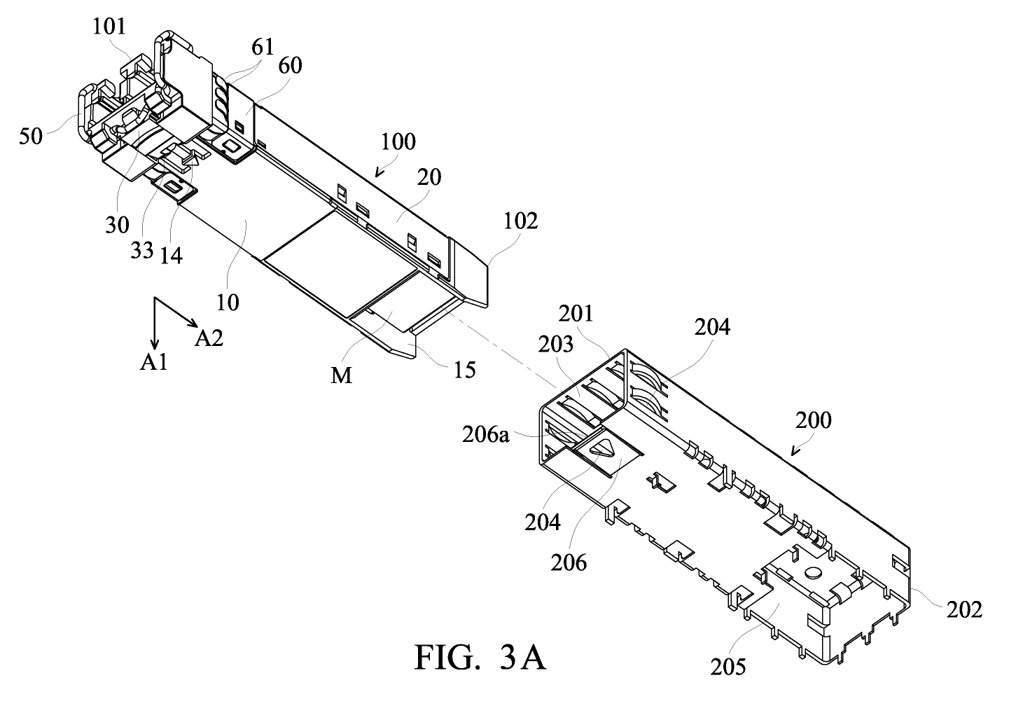

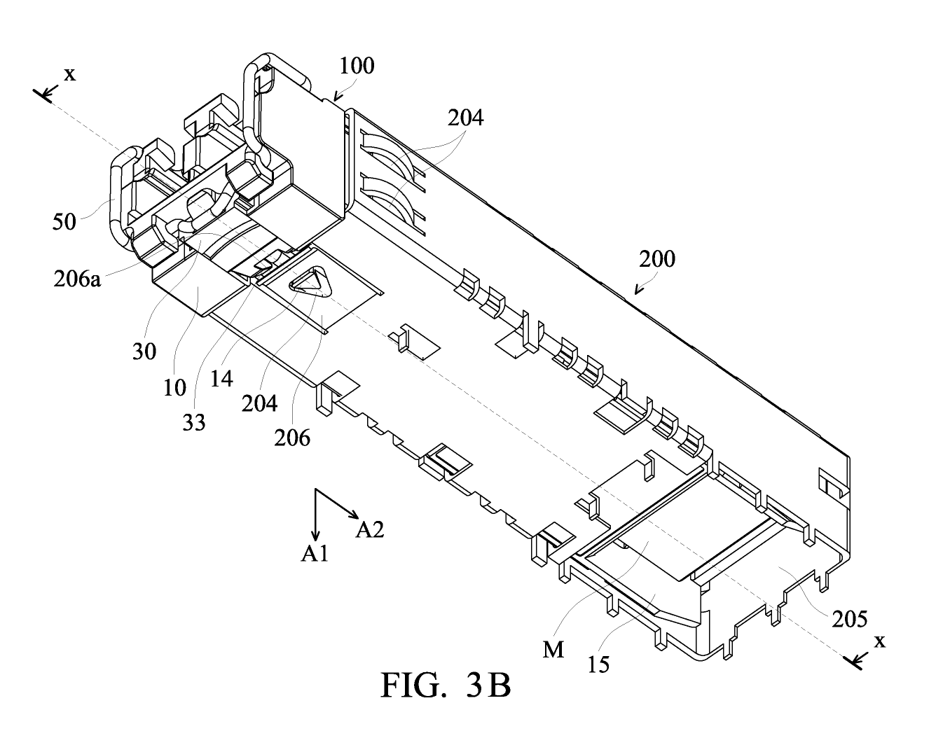

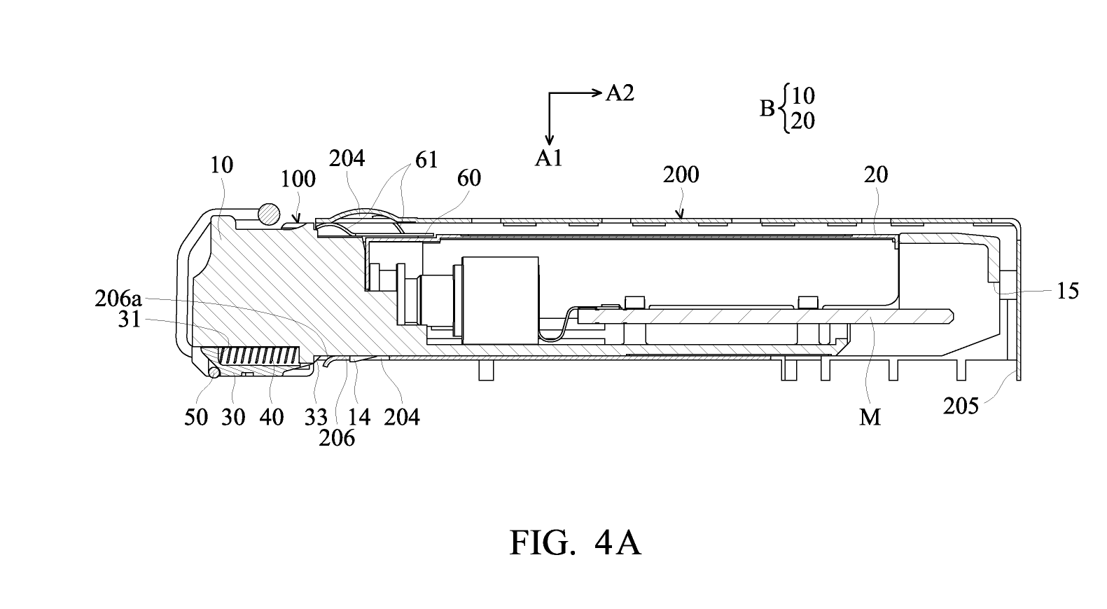

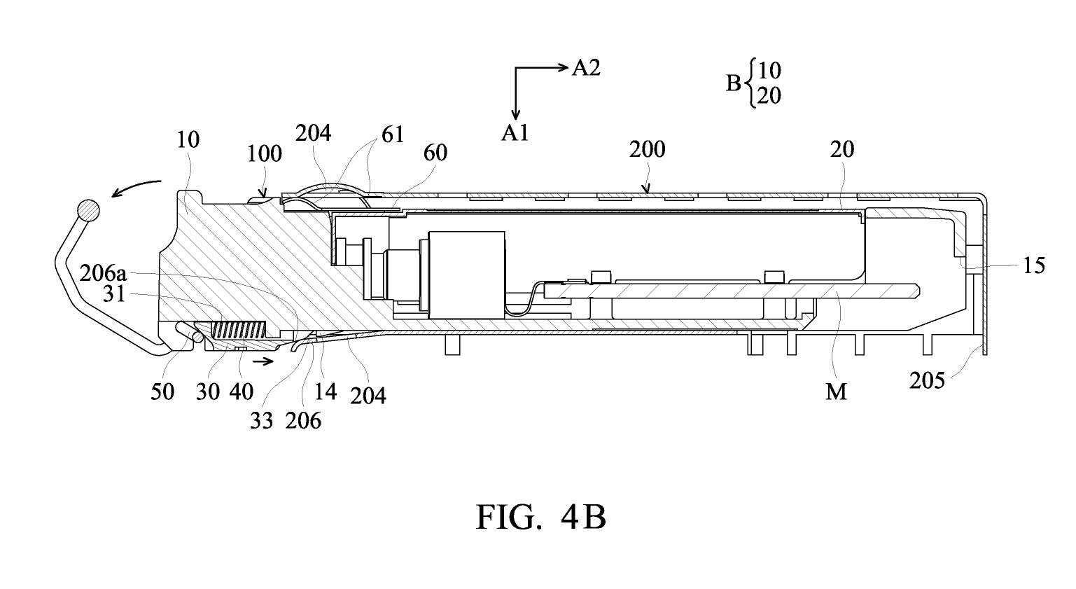

Referring to FIG. 3A, the optical transceiver 100 can be joined into a housing 200. The housing 200 comprises a third end 201, a fourth end 202 opposite to the third end 201, a first opening 203, a plurality of holes 204, and a second opening 205. The first opening 203 is formed at the third end 201, and the second opening 205 is formed at the fourth end 202. Specifically, one of the holes 204 is disposed on a flexible sheet 206 of the housing 200. As shown in FIG. 3A, the second end 102 of the optical transceiver 100 can be inserted into the housing 200 along the second direction A2 through the first opening 203. After the optical transceiver 100 and the housing 200 are assembled to each other, the protrusion 14 protrudes from the hole 204 on the flexible sheet 206, such that the optical transceiver 100 is fixed in the housing 200. Additionally, the extending portion 61 of the protecting structure 60 can join to the holes 204 or tightly contact the inner wall of the housing 200 (as shown in FIG. 4), such that the effect of EMI and ESD protections can be improved, and the optical transceiver 100 can be stably positioned relative to the housing 200.

In this embodiment, the housing 200 can be fixed in an electronic device (not shown), such as desktop computer, laptop computer, smartphone, or on the circuit board of a portable electronic device. As shown in FIG. 3B, when the optical transceiver 100 and the housing 200 are assembled to each other, the second hole 15 is located corresponding to the second opening 205. Thus, the circuit board M in the recess 11 can electrically connect to a circuit board of the aforesaid electronic device through the second hole 15 and the second opening 205 for signal communication.

FIG. 4A is a cross-sectional view taken along the line x-x in FIG. 3B. As shown in FIG. 4A, the slider 30 contacts a side of the movable element 50, and the elastic element 40 is disposed in the receiving portion 31, and both ends of the elastic element 40 contact the main body B and the slider 30. Thus, the slider 30 can be fixed in a first position by the spring force of the elastic element 40. It should be noted that the slider 30 has a first inclined surface 33, and the flexible sheet 206 has a second inclined surface 206a, wherein the first inclined surface 33 is adjacent to the second inclined surface 206a.

Referring to FIG. 4B, when an external force is exerted on the movable element 50 to rotate counterclockwise relative to the base 10, the movable element 50 pushes the slide 30, such that the slider 30 moves through the groove 13 along the second direction A2 from the first position to a second position. The first inclined surface 33 of the slider 30 can slide along the second inclined surface 206a of the flexible sheet 206, such that the flexible sheet 206 is deformed to be curved. Thus, the protrusion 14 can be released from the hole 204 on the flexible sheet 206, and the optical transceiver 100 can be pulled along a direction opposite to the second direction A2, such that the optical transceiver 100 is separated from the housing 200. In this embodiment, the thickness of the protrusion 14 decreases along the second direction A2.

After the optical transceiver 100 is separated from the housing 200, the external force can be released, such that the slider 30 is moved from the second position to the first position along the direction opposite to the second direction A2 by the spring force of the elastic element 40, and the movable element 50 rotates clockwise relative to the base 10 to the position as shown in FIG. 4A. Thus, the operational reliability between the slider 30 and the housing 200 can be improved.

Moreover, if the movable element 50 is broken, the user can directly push the slider 30 along the second direction A2 to separate the optical transceiver 100 from the housing 200 (the friction can be enhanced by the notch 32, such that the slider 30 can be easily pushed by the user).

In summary, an optical transceiver is provided in the invention. The movable element and the slider can automatically resume by the spring force of the elastic element, such that the operation steps can be simplified, and the operational reliability between the slider and the housing can be improved. The cover and the base can be assembled by fastening, riveting, or locking to fix the circuit board (or other optical transceiver elements), and the available space within the recess can also be enlarged. Furthermore, the optical transceiver can be stably positioned relative to the housing by the extending portions of the protecting structure.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, compositions of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps. Moreover, the scope of the appended claims should be accorded the broadest interpretation so as to encompass all such modifications and similar arrangements.

While the invention has been described by way of example and in terms of preferred embodiment, it is to be understood that the invention is not limited thereto. On the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. An optical transceiver comprising:
a main body, comprising a base, a cover, a protrusion, and a groove, wherein the protrusion and the groove are formed on a side of the main body, and the groove extends along a direction toward the protrusion;
a circuit board, clamped between the base and the cover, and the circuit board is not parallel to a protruding direction of the protrusion;
a slider, movably connected to the groove, wherein when an external force is exerted on the slider, the slider is moved from a first position to a second position;
an elastic element, connected between the slider and the main body, wherein when the external force is released, the slider is moved from the second position to the first position by the elastic element; and
a movable element, connected to the main body and the slider, wherein the movable element rotates to push the slider along the groove.

2. The optical transceiver as claimed in claim 1, wherein the cover and the base are assembled to each other along a first direction with the circuit board clamped therebetween.

3. The optical transceiver as claimed in claim 1, wherein the optical transceiver further comprises a protecting structure, and the protecting structure comprises a plurality of extending portions disposed outside the main body and press-fitted to a housing.

4. The optical transceiver as claimed in claim 1, wherein the circuit board has at least one terminal connecting with a fiber.

5. The optical transceiver as claimed in claim 1, wherein the cover and the base are assembled to each other by fastening, riveting, or locking.

6. The optical transceiver as claimed in claim 1, wherein the cover and the base have a U-shaped structure.

7. An optical transceiver comprising:
a main body, comprising a protrusion and a groove, wherein the protrusion and the groove are formed on a side of the main body, and the groove extends along a direction toward the protrusion;
a circuit board, disposed in the main body, and the circuit board is not parallel to a protruding direction of the protrusion;
a slider, movably connected to the groove, wherein when an external force is exerted on the slider, and the slider is moved from a first position to a second position;
an elastic element, connected between the slider and the main body, wherein when the external force is released, the slider is moved from the second position to the first position by the elastic element; and
a movable element, connected to the main body and the slider, wherein the movable element rotates to push the slider along the groove.

8. The optical transceiver as claimed in claim 7, wherein the optical transceiver further comprises a protecting structure, and the protecting structure comprises a plurality of extending portions, wherein the extending portions are disposed outside the main body and press-fitted to a housing.

9. The optical transceiver as claimed in claim 7, wherein the circuit board connects with at least one terminal, connecting with a fiber.

10. An optical transceiver comprising:
a main body, comprising a protrusion and a groove, wherein the protrusion and the groove are formed on a side of the main body, and the groove extends along a direction toward the protrusion;
a circuit board, disposed in the main body, and the circuit board is not parallel to a protruding direction of the protrusion;
a slider, movably connected to the groove, wherein when an external force is exerted on the slider, the slider is moved from a first position to a second position;
a protecting structure, comprising a plurality of extending portions, wherein the extending portions are disposed outside the main body and press-fitted to a housing; and
a movable element, connected to the main body and the slider, wherein the movable element rotates to push the slider along the groove.
